(19) United States
(12) Patent Application Publication
(10) Pub. No.: US 2016/0270621 A1
(43) Pub. Date: Sep. 22, 2016

(54) SURFACE-CLEANING APPARATUS

(71) Applicant: TECHTRONIC FLOOR CARE TECHNOLOGY LIMITED, Tortola (VG)

(72) Inventor: Phil Grove, West Midlands (GB)

(21) Appl. No.: 15/034,595

(22) PCT Filed: Feb. 7, 2014
(86) PCT No.: PCT/GB14/50365

§ 371 Date: May 5, 2016

(30) Foreign Application Priority Data
Nov. 8, 2013 (GB) 1319743.9

(51) Int. Cl. A47L 13/22; B08B 1/00; B08B 3/00

(52) U.S. Cl. CPC A47L 13/225; B08B 3/00; B08B 1/001

(57) ABSTRACT

A surface cleaning apparatus including a cleaning head having a body that defines a footprint to sit adjacent a surface to be cleaned, the body including first and second parts that are moveable relative to one another between a first configuration and a second configuration, such that the area of the footprint is greater when in the first configuration than when in the second configuration.

### CROSS-REFERENCE TO RELATED APPLICATIONS

This application is a U.S. national phase of international application PCT/GB2014/050365, filed Feb. 7, 2014, which claims priority to U.K. Patent Application No. 1319743.9, filed Nov. 8, 2013, the entire contents all of which are hereby incorporated by reference herein.

### BACKGROUND

This invention relates to a surface cleaning apparatus. More particularly, but not exclusively, this invention relates to an apparatus for cleaning a surface such as a floor or wall which utilises a source of steam.

The use of steam cleaners for cleaning floor and other surfaces is well known. For cleaning floor surfaces, a steam cleaner typically has a cleaning head comprising a body able to be moved, by a user, over the surface to be cleaned, the body being adapted to carry a cleaning element of or including a fabric/textile or other material of a steam permeable absorbent nature. Steam (or very hot water) is emitted from the body and passes through the cleaning element to contact the surface being cleaned, with the effect of loosening dirt from the surface. Dirty water from condensation of the steam on the surface is absorbed by the cleaning element.

The cleaning head, to enable it to be manipulated over the surface being cleaned, may be attached to a wand and steam supplied thereto by way of a hose from a separate steam generator. Alternatively, the wand may itself be provided with a steam generator and supply of water, to form a self-contained steam cleaning device, sometimes referred to as a “stick” or “mop” type of steam cleaner.

A further provision known in such a steam cleaner is the ability to store a cleaning agent, e.g. a solution of a suitable detergent, to assist the cleaning operation.

When used to clean a surface in a home, office or industrial environment, for example, known cleaning heads must be manipulated carefully by a user to navigate the cleaning head around objects in the environment. Significant contact force between a cleaning head and an item of furniture, for example, may result in the furniture or cleaning head being damaged. Furthermore, when cleaning a surface in a restricted space, a user may find it difficult to move the cleaning head into position close to, around, or behind an object.

### SUMMARY

It should be appreciated that the invention is applicable to many other types of surface cleaning apparatus, for example, carpet washing apparatus/vacuums.

According to an aspect of the invention we provide a surface cleaning apparatus including a cleaning head having a body that defines a footprint to sit adjacent a surface to be cleaned, the body including first and second parts that are moveable relative to one another between a first configuration and a second configuration, such that the area of the footprint is greater when in the first configuration than when in the second configuration.

### BRIEF DESCRIPTION OF THE DRAWINGS

Embodiments of the invention will now be described, by way of example only, with reference to the following figures, of which:

FIG. 1 is a perspective view of an embodiment of the cleaning head according to the invention, shown in a first configuration;

FIG. 2 is a perspective view of an embodiment of the cleaning head, shown in a second configuration;

FIG. 3 is a plan view of the top of the cleaning head of FIG. 1, shown in the first configuration;

FIG. 4 is a plan view of the underside of the cleaning head of FIG. 1, shown in the first configuration;

FIG. 5 is a plan view of the top of the cleaning head of FIG. 1, shown in the second configuration;

FIG. 6 is a plan view of the underside of the cleaning head of FIG. 1, shown in the second configuration;

FIG. 7 is a cross-sectional front view of a cleaning head according to an embodiment of the invention;

FIG. 8 is a cross-sectional front view of a cleaning head according to an embodiment of the invention;

FIG. 9 is a cross-sectional front view of a cleaning head according to an embodiment of the invention;

FIG. 10 is a cross-sectional front view of a cleaning head according to an embodiment of the invention;

FIG. 11 is a diagrammatic plan view of a pad of a cleaning head according to an embodiment of the invention;

FIG. 12 is a diagrammatic plan view of a pad of a cleaning head according to an embodiment of the invention; and

FIG. 13 is a front perspective view of a surface cleaning apparatus including a cleaning head according to embodiments of the invention.

### DETAILED DESCRIPTION

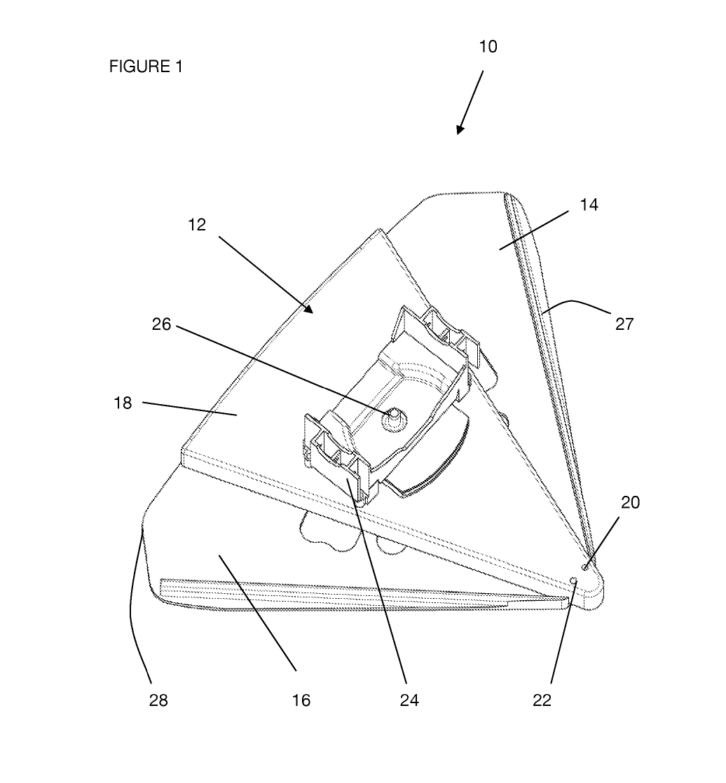

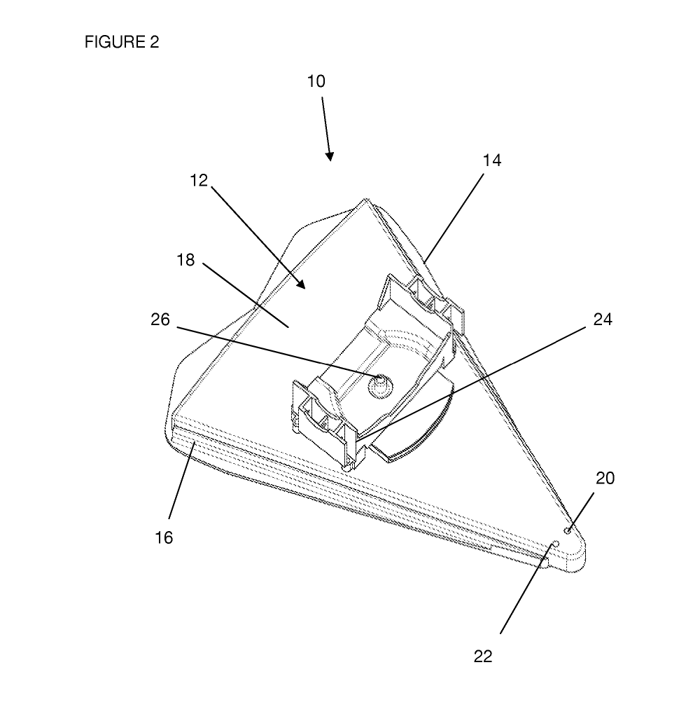

With reference to the drawings, a surface cleaning apparatus has a surface cleaning head 10, having a body (shown generally at 12) comprising a first part 18 and a second part 14 that are moveable relative to one another. When positioned adjacent a surface to be cleaned, the body 12 defines a footprint over that surface—in other words, the area of the surface that is covered by the body 12. The first part 18 and second part 14 of the body 12 are moveable between a first configuration (as shown in FIGS. 1, 3 and 4) and a second configuration (as shown in FIGS. 2, 5 and 6), such that the area of the footprint is greater when in the first configuration than when in the second configuration.

In embodiments, and as shown in the Figures, the body 12 includes a third part 16 which is moveable relative to the first part 18 between a first position in which the body 12 is in its first configuration and a second position in which the body is in its second configuration. The third part 16 may be located relative to the body 12 as a mirror-image of the second part 14. Configured in this way, the second part 14 may pivot counter clockwise relative to the first part 18 and the third part 16 may pivot clockwise relative to the first part 18 when moving from the first to the second configuration. It should be understood that other configurations are possible, and that the second and third parts 14, 16 may not be mirror-images of one another. The second 14 and third 16 parts are moveable independently of one another. The body 12 also includes a cover that extends over substantially the entire first, second and third 18, 14, 16 parts so as to form a sealed upper surface of the cleaning head 10. The cover may comprise multiple parts that move relative to one another and are sealed relative to one another, so that, for example, the second and third parts 14, 16 have cover parts that move relative to the cover of the first part 18, but maintain a seal therebetween.

As shown in the Figures, the cleaning head is generally triangular in plan view. The first configuration provides a ‘wide’ triangular shape, in which the second and third parts 14, 16 form two corners of the triangle that span outwardly from the first part 18, which has a thinner triangular wedge-shape. Movement of the second and third parts 14, 16 to the first, wider, configuration is described herein as movement ‘outwards’, and movement towards the second, narrow, configuration is described as movement ‘inwards’.

A forward-facing edge of each of the second and third parts 14, 16 includes a ridge 27 that is adapted to abut a corresponding surface of the first part 18 of the body 12. Abutment between the first part 18 and second and/or third parts 14, 16 occurs when the body 12 moves to its second configuration, and the ridge 27 prevents further pivoting movement of either the second or third parts 14, 16 beyond their second respective positions.

When the body 12 is in its first configuration the surface cleaning apparatus 10 may be stood upright unsupported on the wide base provided by the body 12. Furthermore, when in its first configuration, in use the area of the body 12 adjacent the surface to be cleaned is relatively large, so that a large area of the surface may be cleaned when the apparatus is in a given position.

When the body 12 is in its second configuration, the body 12 of the apparatus 10 defines a smaller footprint (than when it is in the first configuration), so that it may be moved more easily into or through areas of restricted space. For example, to clean behind a pedestal basin, the cleaning head must be moved to a first side of the basin, and then moved around the front of the basin to reach the other side of the basin, because the gap between the pedestal and the wall against which the basin is mounted is too narrow for a typical cleaning head to pass through. In embodiments, and as shown in FIGS. 2, 5 and 6, the second configuration of the body 12 provides a footprint of narrow width compared to the first configuration. In this case the body 12 may be moved to its second configuration so that the cleaning head may pass through the narrow gap behind the pedestal. Another advantage of being able to place the body 12 in its smaller second configuration is that the apparatus may be stored more easily in a tight space, such as a cleaning equipment storage cupboard.

In embodiments, the cleaning head includes a securing mechanism operable to secure the body 12 in the second configuration, so that the smaller footprint of the apparatus 10 can be maintained while cleaning between narrow gaps or in areas of restricted space. The securing mechanism may include a latch or a bolt, for example. In embodiments, the securing mechanism is also operable to secure the body 12 in the first configuration. Alternatively, a second securing mechanism may be provided, that is operable to secure the body 12 in the first configuration.

In embodiments, and as shown in the Figures, the second part 14 of the body 12 is pivotally moveable relative to the first part 18, and the third part 16 is pivotally moveable relative to the first part 18, about respective pivot points 20, 22. The pivot points 20, 22 may, for example, include pins located within apertures defined in the first 18, and second 14/third 16 parts, respectively. In the embodiments shown, the second 14 and third 16 parts are pivotable about separate axes defined by pivot points 20, 22. Alternatively, the second and third parts 14, 16 may pivot about a common axis resulting in a single pivot point 20, 22.

The cleaning head 10 includes a biasing mechanism that biases the second part 14 of the body outwards towards its first position, and the same or a further biasing mechanism biases the third part 16 of the body towards its first position. The biasing mechanism(s) is one or more compression springs, disposed relative to the body 12 so as to act against opposed surfaces of the first part 18 and second and/or third part(s) 14, 16, respectively, so as to bias the second and/or third part(s) 14, 16 outwardly to their first position(s). Alternatively, the biasing mechanism(s) may be a torsion spring.

The body 12 provides a connection portion 24 for connection to a handle or wand of a cleaning device. The connection portion 24 provides a recess into which a portion of the handle or wand is receivable, and a connection mechanism for holding the part of the handle or wand securely to the body 12 of the cleaning head 10.

In use, the cleaning head 10 is moved with the apparatus by a user. The cleaning head 10 may come into contact with walls, furniture, and other obstacles. Where a user exerts a sufficient force on either the second or third parts 14, 16 of the cleaning head 10, to push it into contact with a wall or object, that second/third part is pushed inwardly against the biasing force of the spring. When the force is released, the spring causes the second/third part to move back to its first position. In general use, contact between the second/third parts 14, 16 and objects occurs when the cleaning head 10 is being moved in a forwards direction. Of course, it is also possible for contact to occur when the use moves the cleaning head backwards, to withdraw the cleaning head 10 from between two objects, for example. Due to the curved or angled shape of the backmost part 28 of the second/third parts, contact between that part and an object exerts an inwardly-directed force on the second/third part 14, 16, to cause it to move inwardly towards its second position. This allows the cleaning head 10 to be withdrawn through a narrow gap, of lesser width than the body 12 in its first configuration.

In embodiments, a user-operable actuating mechanism is provided. Operation of the mechanism causes movement of the parts of the body 12 between the first configuration and the second configuration. In embodiments, the actuating mechanism may interact with the securing mechanism(s). For example, the actuating mechanism may include a release lever for a latch mechanism comprised by the securing mechanism, such that releasing the latch causes the second and/or third parts 14, 16 to move outwardly under the biasing force of the or each spring, to their respective first positions. The actuating mechanism may be operable by a release button, a hand or foot-operated switch, or the like.

The cleaning apparatus includes a fluid storage container. In embodiments, the apparatus is a steam cleaning device, and the fluid storage container is a water storage container, and the apparatus includes a steam generator in fluid communication with the water storage container, the steam generator including at least one heating element. In embodiments, the apparatus includes a pump for feeding water from the water storage container to the steam generator, and a fluid passage for directing steam from the steam generator to the cleaning head 10 of the apparatus. In other embodiments the apparatus does not include a pump for feeding water from the storage container to the steam generator, relying instead on the effect of gravity to feed water from the storage container to the steam generator. The fluid passage is generally provided in the handle or wand of the cleaning apparatus, and is connected to a fluid connection port 26 provided within the connection portion 24 of the cleaning head.

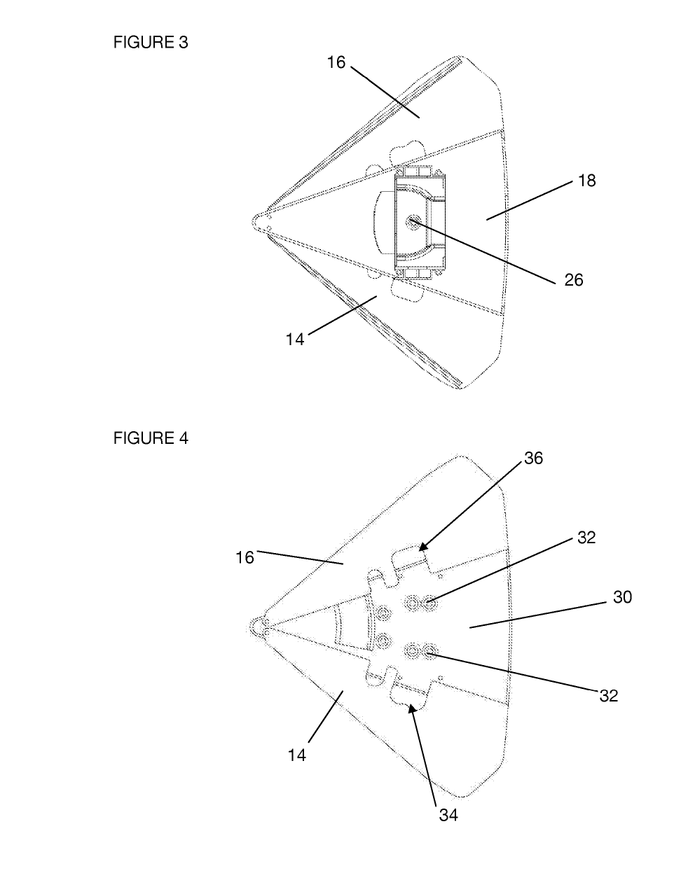

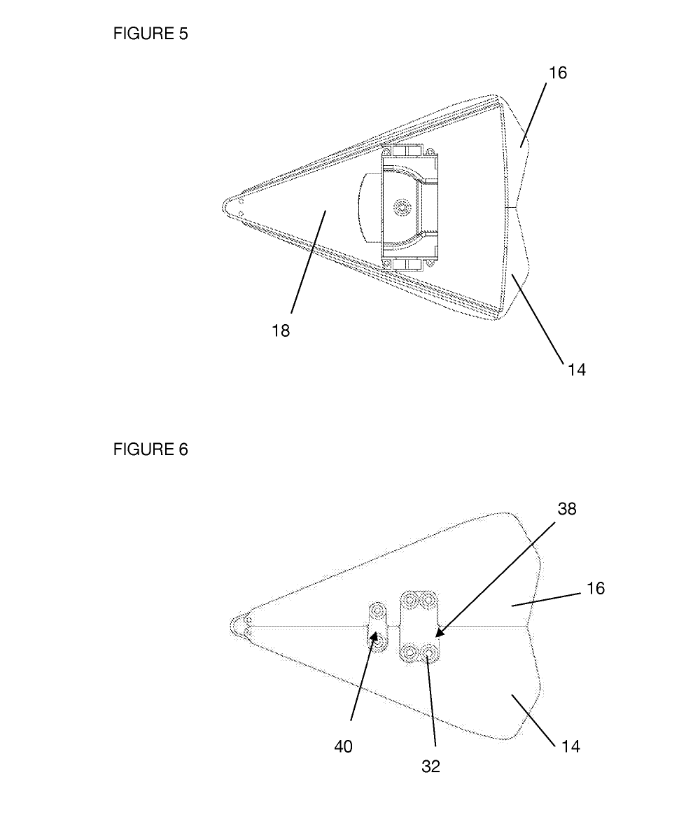

As shown in FIGS. 3, 4, 5 and 6, the first part 18 of the body comprises a plurality of fluid passages 32 that lie beneath the connection portion 24. The steam that is supplied to the body 12 through fluid connection port 26 is provided to a volume 30 defined generally underneath the first part 18 of the body 12 through the fluid passages 32. Each of the second and third parts 14, 16 defines at least one opening (shown generally at 34 and 36, respectively), such that when the second and third parts 14, 16 are in their respective second positions, as shown in FIGS. 5 and 6, the openings through the second and third parts align with the fluid passages 32 above, to form apertures 38 and 40. This configuration allows steam to pass to the underside of the body 12, to provide steam to the floor-cleaning lower surface of the cleaning head 10, whether the cleaning head is in its first or its second configuration.

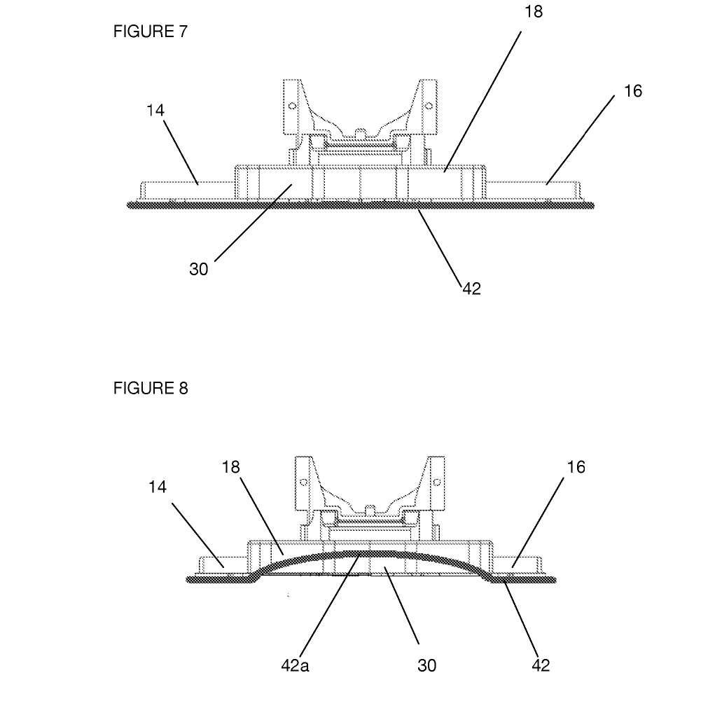

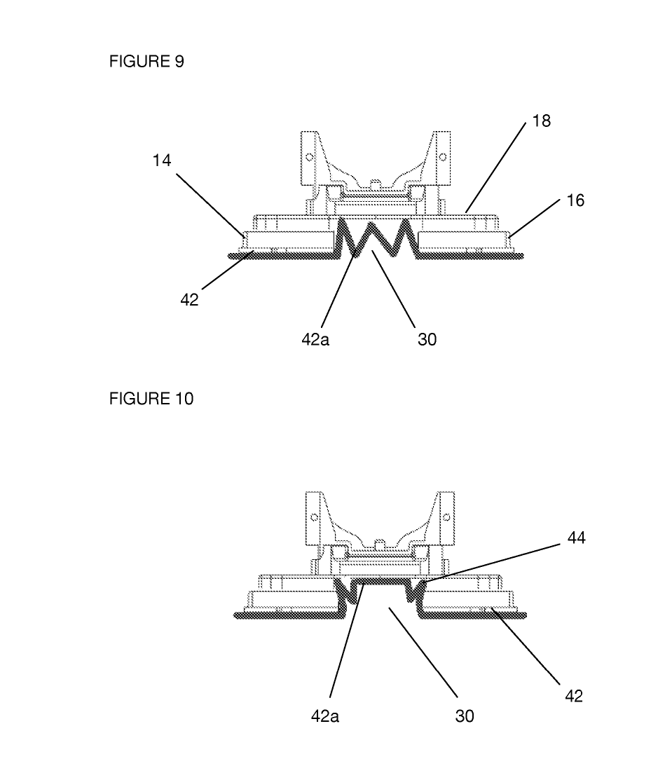

As shown in FIGS. 7 to 10 the cleaning head 10 includes a pad 42 of material that covers at least a portion of the body 12, on the surface-facing side of the cleaning head 10. The pad 42 comprises an absorbent material, and, in embodiments, the pad 42 covers the entire footprint of the surface-facing side of the cleaning head 10. In embodiments, further pads are provided on the second and/or third parts 14, 16, that are separate from the pad provided on the first part 18.

The volume 30 generally defined by the cleaning head 10 receives steam from the steam generator via the fluid passage, the volume being formed substantially within the first part 18 of the body 12, and enclosed by the pad 42 covering the surface-facing side of the body 12. A second volume is formed substantially within the second part of the body and is connected to the volume of the first part 14 by a flexible fluid passage. Similarly, a third volume is formed substantially within the third part 16 of the body, and is connected to the volume of the first part 14 by a flexible fluid passage. The or each volume 30 may be enclosed at least partially by the pad 42 (or multiple pads). Alternatively, the body 12 may define one volume 30 that encompasses the first, second and third parts 18, 14, 16, and a single pad 42 may be provided that covers substantially the entire footprint of the cleaning head 10.

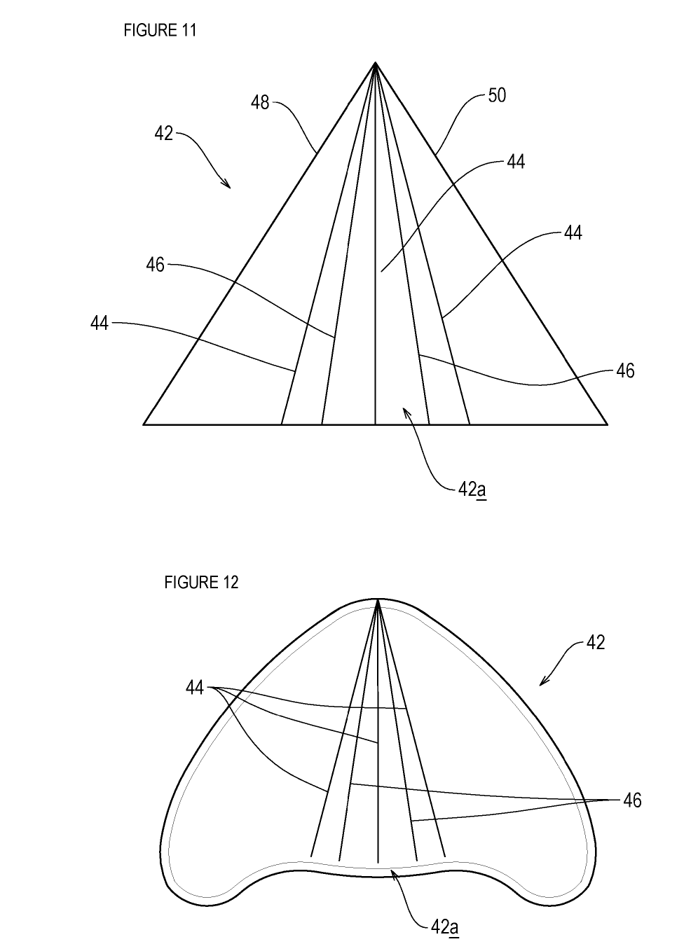

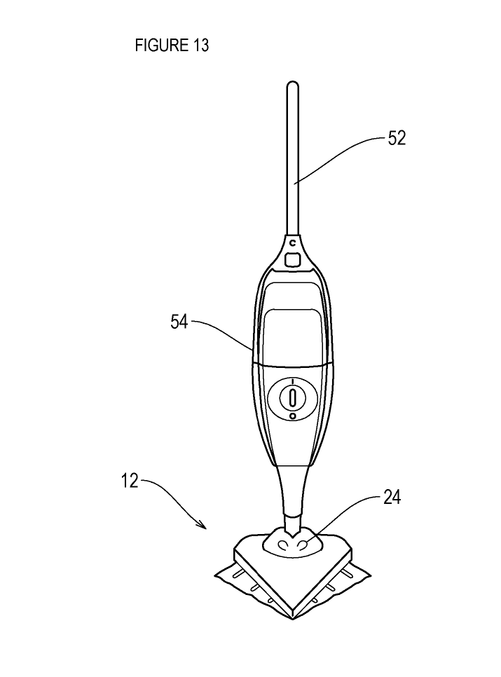

In embodiments, as shown in FIGS. 11 and 12, the pad 42 comprises a pleated portion 42a along which one or more folds occur as the body 12 is moved between its first and its second configuration. The pad is configured such that movement of the parts of the body 12 from their first configuration to their second configuration causes a portion of the pad to fold within the body 12 of the cleaning head 10, as illustrated in FIGS. 8 to 10. In other words, a crease is formed along a central portion 42a of the pad 42, so that when the second and third parts 14, 16 move towards one another, the excess material of the pad folds upwardly within the body 12. Lines of stitching 44 are provided in the pad 42 between the front and the rear of the pad 42, so that when the side edges 48, 50 of the pad 42 are moved towards one another, the pad 42 folds into pleats defined by the lines of stitching 44. Preferably at least three lines of stitching 44 are provided, thus allowing the pleated portion 42a of the pad 42 to fold upwardly into the volume 30 defined within the body 12. Optional further lines of stitching 46 may be provided to create additional pleats when the pad 42 is folded.

Due to the concentration of steam within the body 12 during use, it is advantageous that the portion of the pad that folds within the body 12 of the cleaning head 10 comprises a portion of increased absorptiveness. For example, a region of the pad around the pleated portion may comprise a superabsorptive material.

FIG. 13 shows a surface cleaning device that includes a cleaning head 10 according to embodiments of the invention. The body 12 of the cleaning head is connected to a main body 54 of the apparatus via the connection portion 24. The main body 54 provides a handle 52 (but, in other embodiments, may provide a wand or the like).

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A surface cleaning apparatus comprising:
a cleaning head having a body that defines a footprint to sit adjacent a surface to be cleaned, the body including first and second parts that are moveable relative to one another between a first configuration and a second configuration, such that the area of the footprint is greater when in the first configuration than when in the second configuration, the second part of the body being moveable relative to the first part between a first position in which the body is in its first configuration and a second position in which the body is in its second configuration, and the cleaning head includes a biasing mechanism to bias the second part of the body towards its first position.

2. An apparatus according to claim 1, wherein the head includes a securing mechanism operable to secure the body in the second configuration.

3. An apparatus according to claim 1, wherein the or a second securing mechanism is operable to secure the body in the first configuration.

4. An apparatus according to claim 1, wherein the second part of the body is pivotally moveable relative to the first part.

5. An apparatus according to claim 1, wherein the body includes a third part which is moveable relative to the first part between a first position in which the body is in its first configuration and a second position in which the body is in its second configuration.

6. An apparatus according to claim 5 wherein the third part is pivotally moveable relative to the first part.

7. (canceled)

8. An apparatus according to claim 6, wherein the second and third parts are moveable independently of one another.

9. (canceled)

10. An apparatus according to claim 5, wherein the or a further biasing mechanism biases the third part of the body towards its first position.

11. An apparatus according to claim 1, including a user-operable actuating mechanism to cause movement of the parts of the body between the first configuration and the second configuration.

12. (canceled)

13. An apparatus according to claim 1 further including a water storage container;
a steam generator in fluid communication with the water storage container, the steam generator including a heating element(s);
a fluid passage for directing steam from the steam generator to the cleaning head of the apparatus; and
a pad of material that covers at least a portion of a surface-facing footprint of the body.

14.-16. (canceled)

17. An apparatus according to claim 13, wherein the cleaning head defines a volume for receiving steam from the steam generator.

18. An apparatus according to claim 17, wherein the volume is formed substantially within the first part of the body.

19.-20. (canceled)

21. An apparatus according to claim 13 wherein the pad is configured such that movement of the parts of the body from their first configuration to their second configuration causes a portion of the pad to fold within the body of the cleaning head.

22. An apparatus according to claim 21, wherein the pad comprises pleating along which said fold occurs.

23. An apparatus according to claim 21, wherein the portion of the pad that folds within the body of the cleaning head comprises a portion of increased absorptiveness.

24.-26. (canceled)
